(19) United States
(12) Patent Application Publication
(10) Pub. No.: US 2020/0072456 A1
(43) Pub. Date: Mar. 5, 2020

(54) Modular Under Cabinet Systems

(71) Applicant: Eaton Intelligent Power Limited, Dublin (IE)

(72) Inventors: Charles Vasquez, Peachtree City, GA (US); Mustafa Bengali, Newnan, GA (US); Robert Smith, Fayetteville, GA (US)

(21) Appl. No.: 16/559,098

(22) Filed: Sep. 3, 2019

Related U.S. Application Data
(60) Provisional application No. 62/725,575, filed on Aug. 31, 2018.

(51) Int. Cl. F21V 33/00; F21V 23/06; F21V 15/01

(52) U.S. Cl. CPC F21V 33/0012; F21W 2131/301; F21V 15/01; F21V 23/06

(57) ABSTRACT

A modular under cabinet system can include a first under cabinet module disposed in a first location, wherein the first under cabinet module performs a first function, where the first under cabinet module receives power from a source, where the first cabinet module performs the first function using the power. The system can also include a second under cabinet module disposed in a second location, where the second under cabinet module is coupled to the first under cabinet module to allow for the transfer of the power therebetween, where the second under cabinet module performs a second function using the power.

### CROSS-REFERENCE TO RELATED APPLICATIONS

This application claims priority under 35 U.S.C. § 119 to U.S. Provisional Patent Application Ser. No. 62/725,575, titled “Modular Under Cabinet Systems” and filed on Aug. 31, 2018, the entire contents of which are hereby incorporated herein by reference.

### TECHNICAL FIELD

Embodiments described herein relate generally to light fixtures, and more particularly to systems, methods, and devices for modular systems mounted under a cabinet.

### BACKGROUND

In certain applications, the size and shape of a light fixture can be constrained. For example, in a kitchen setting, a user may want one or more light sources mounted under cabinetry. However, because of clearance concerns (such as a user's ability to work and/or store items on a counter under the cabinetry), aesthetics, and/or any of a number of other considerations, any light fixtures mounted to the underside of the cabinetry will be constrained. A light fixture mounted to an underside of a cabinet can be called an under cabinet light fixture. When multiple light fixtures are used in such an application, these light fixtures can share a common source of power and/or control signals.

### SUMMARY

In general, in one aspect, the disclosure relates to a modular under cabinet system. The modular under cabinet system can include a first under cabinet module disposed in a first location, where the first under cabinet module performs a first function, where the first under cabinet module receives power from a source, where the first under cabinet module performs the first function using the power. The modular under cabinet system can also include a second under cabinet module disposed in a second location, where the second under cabinet module is coupled to the first under cabinet module to allow for the transfer of the power therebetween, where the second under cabinet module performs a second function using the power.

In another aspect, the disclosure can generally relate to an under cabinet module of a modular under cabinet system. The under cabinet module can include a housing having a body. The under cabinet module can also include a first coupling feature disposed on the body of the housing, where the first coupling feature is configured to couple to a first adjacent module of the modular under cabinet system. The under cabinet module can further include a first functional feature disposed, at least in part, within the body of the housing, where the first functional feature does not provide general illumination. The first functional feature can consume an amount of energy that is less than a threshold required for energy efficiency certification.

These and other aspects, objects, features, and embodiments will be apparent from the following description and the appended claims.

### BRIEF DESCRIPTION OF THE DRAWINGS

The drawings illustrate only example embodiments of under cabinet light fixtures and are therefore not to be considered limiting of its scope, as under cabinet light fixtures may admit to other equally effective embodiments. The elements and features shown in the drawings are not necessarily to scale, emphasis instead being placed upon clearly illustrating the principles of the example embodiments. Additionally, certain dimensions or positions may be exaggerated to help visually convey such principles. In the drawings, reference numerals designate like or corresponding, but not necessarily identical, elements.

FIGS. 1A through 1C show various views of a module in the form of an under cabinet light fixture currently used in the art.

FIGS. 2A and 2B show various views of another module in the form of an under cabinet light fixture with end caps currently used in the art.

FIG. 3 shows a couple of modules in the form of under cabinet light fixtures coupled to each other currently used in the art.

FIG. 4 shows a couple of modules in the form of under cabinet light fixtures coupled to each other currently used in the art.

FIG. 5 shows a couple of modules in the form of under cabinet light fixtures coupled to each other currently used in the art.

FIGS. 6A through 6E show various views of a subassembly having multiple modules coupled to each other in accordance with certain example embodiments.

FIG. 7 shows a block diagram of a subassembly having multiple modules coupled to each other in accordance with certain example embodiments.

### DETAILED DESCRIPTION OF EXAMPLE EMBODIMENTS

The example embodiments discussed herein are directed to systems, apparatuses, and methods for modular under cabinet systems. Example systems described herein include multiple modules that are coupled to each other. Each module in an example system can serve one or more purposes. For example, a module in an example system can be a light fixture that emits light. As another example, a module in an example system can include a USB port that can be used to charge an electrical device (e.g., a cell phone, a MP3 player).

As yet another example, a module in an example system can include one or more energy storage devices (e.g., batteries). As still another example, a module in an example system can include a sensor device. In such a case, the sensor device can be used in the operation of another module. As yet another example, a module in an example system can include a ground fault circuit interrupter (GFCI) receptacle. As still another example, a module in an example system can include a voice-activated controller.

A module commonly known in the art is a light fixture (also called an under cabinet light fixture). When a module is a light fixture, the module can have one or more of a number of types of sockets into which one or more light sources are electrically and mechanically coupled. Examples of types of sockets can include, but are not limited to, an Edison screw base of any diameter (e.g., E26, E12, E14, E39), a bayonet style base, a bi-post base, a bi-pin connector base, a wedge base, and a fluorescent tube base.

A light source of an under cabinet fixture can electrically and mechanically couple to the socket and can be of a light source type that corresponds to the type of socket. Examples of light source types of the light source can include, but are not limited to, light-emitting diodes (LEDs), incandescent lamps, halogen lamps, G10/GU10, G9/GU9, AR111/PAR36, T3, MR-11, and MR-16. If the light source of an under cabinet light fixture is a LED, the LED can be of one or more of a number of types of LED technology, including but not limited to discrete LEDs, LED arrays, chip-on-board LEDs, edge lit LED panels, and surface mounted LEDs.

Each module in an example system can be mounted in spaces with relatively low clearance, such as on the bottom of a cabinet in a kitchen, a lab, or a doctor's office. Alternatively, each module in an example system described herein can be used in other applications where clearance is not at issue. Each module in an example system can be electrically coupled, directly or indirectly, to a power source to provide power and/or control to the module. The power source can provide the module with one or more of a number (and/or a range) of voltages, including but not limited to 120 V alternating current (AC), 110 VAC, 240 VAC, 24 V direct current (DC), and 0-10 VDC.

Each module of an example system can be of any size and/or shape. Further, each module can have one or more of any of a number of features (e.g., light emission, connectivity, port availability). An example system can be located indoors and/or outdoors and can be mounted to a surface (e.g., cabinet, wall, ceiling, pillar), be part of a lamp or other electrical device, or be used with any other suitable mounting instrument. Each module of an example system can be used in residential, commercial, and/or industrial applications. A module of an example system can operate from a manual fixture (e.g., on/off switch, dimming switch, pull chain), a photocell (which can be part of another module), a timer, and/or any other suitable mechanism.

Any components (e.g., end cap) of a module of an example system, or portions thereof, described herein can be made from a single piece (as from a mold, injection mold, die cast, or extrusion process). In addition, or in the alternative, a component (or portions thereof) of a module of an example system can be made from multiple pieces that are mechanically coupled to each other. In such a case, the multiple pieces can be mechanically coupled to each other using one or more of a number of coupling methods, including but not limited to epoxy, welding, fastening devices, compression fittings, mating threads, and slotted fittings. One or more pieces that are mechanically coupled to each other can be coupled to each other in one or more of a number of ways, including but not limited to fixedly, hingedly, removeably, slidably, and threadably.

Components and/or features described herein can include elements that are described as coupling, fastening, securing, or other similar terms. Such terms are merely meant to distinguish various elements and/or features within a component or device and are not meant to limit the capability or function of that particular element and/or feature. For example, a feature described as a “coupling feature” can couple, secure, fasten, and/or perform other functions aside from strictly coupling. In addition, each component and/or feature described herein (including each component of an example under cabinet light fixture) can be made of one or more of a number of suitable materials, including but not limited to metal, ceramic, rubber, and plastic.

A coupling feature (including a complementary coupling feature) as described herein can allow one or more components (e.g., an end cap) and/or portions of a module of an example system to become mechanically and/or electrically coupled, directly or indirectly, to another component and/or portion of another module of the example system. Further, one portion of a module of an example system can be coupled to another portion of the same module by the direct or indirect use of one or more coupling features. A coupling feature can include, but is not limited to, a clamp, a portion of a hinge, an aperture, a recessed area, a protrusion, a slot, a spring clip, a tab, a detent, and mating threads.

In addition, or in the alternative, a portion of a module of an example system can be coupled to another portion of the same module or a different module using one or more independent devices that interact with one or more coupling features disposed on a component of the module. Examples of such devices can include, but are not limited to, a pin, a hinge, a fastening device (e.g., a bolt, a screw, a rivet), and a spring. One coupling feature described herein can be the same as, or different than, one or more other coupling features described herein. A complementary coupling feature as described herein can be a coupling feature that mechanically couples, directly or indirectly, with another coupling feature.

In certain example embodiments, the modules (or portions thereof) of example systems described herein meet one or more of a number of standards, codes, regulations, and/or other requirements established and maintained by one or more entities. Examples of such entities include, but are not limited to, Underwriters' Laboratories (UL), the National Electric Code (NEC), the California Energy Commission (CEC), the Department of Energy (DOE), and the Institute of Electrical and Electronics Engineers (IEEE). For example, UL may require that wiring (also called electrical conductors, as defined below) that electrically couples to a module (e.g., an under cabinet light fixture) of an example system cannot be removed by pulling on such wiring from outside the module. As another example, modules of example systems can comply with the Restriction of Hazardous Substances (ROHS) Specification CL-ES-1025.

In addition, or in the alternative, the modules of example under cabinet systems can qualify for certain certifications and programs. For example, the modules of an example under cabinet system can be qualified for the ENERGY STAR® program for promoting energy efficient products. (ENERGY STAR is a registered trademark and service mark of the Environmental Protection Agency, a federal agency of the United States of America.)

As defined herein, an electrical enclosure is any type of connector or housing inside of which is disposed electrical and/or electronic equipment. Such electrical and/or electronic equipment can include, but is not limited to, power supplies, controllers, energy storage devices, electrical cables, and electrical conductors. Examples of an electrical enclosure can include, but are not limited to, a housing of a module, a housing of an electrical connector (or a portion thereof), a sleeve, and a conduit.

As described herein, a user can be any person that interacts with one or more modules of an example under cabinet system. Examples of a user may include, but are not limited to, a consumer, an electrician, an engineer, a mechanic, a home owner, a business owner, a consultant, a contractor, an operator, and a manufacturer's representative. For any figure shown and described herein, one or more of the components may be omitted, added, repeated, and/or substituted. Accordingly, embodiments shown in a particular figure should not be considered limited to the specific arrangements of components shown in such figure.

Further, if a component of a figure is described but not expressly shown or labeled in that figure, the label used for a corresponding component in another figure can be inferred to that component. Conversely, if a component in a figure is labeled but not described, the description for such component can be substantially the same as the description for the corresponding component in another figure. The numbering scheme for the various components in the figures herein is such that each component is a three-digit number or a four-digit number, and corresponding components in other figures have the identical last two digits.

Example embodiments of modular under cabinet systems will be described more fully hereinafter with reference to the accompanying drawings, in which example embodiments of modular under cabinet systems are shown. Modular under cabinet systems may, however, be embodied in many different forms and should not be construed as limited to the example embodiments set forth herein. Rather, these example embodiments are provided so that this disclosure will be thorough and complete, and will fully convey the scope of modular under cabinet systems to those of ordinary skill in the art. Like, but not necessarily the same, elements (also sometimes called components) in the various figures are denoted by like reference numerals for consistency.

Terms such as “first”, “second”, “third”, “height”, “width”, “length” “distal”, “proximal”, “top”, “bottom”, “side”, “left”, and “right” are used merely to distinguish one component (or part of a component or state of a component) from another. Such terms are not meant to denote a preference or a particular orientation, and such terms are not meant to limit embodiments of modular under cabinet systems. In the following detailed description of the example embodiments, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

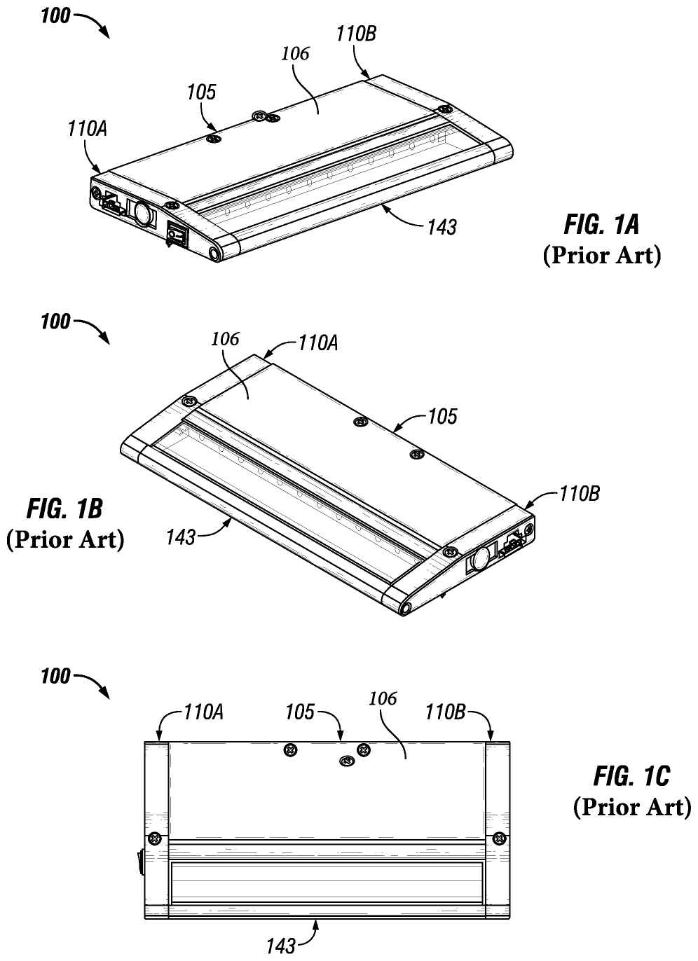

In the current art, under cabinet light fixtures (referred to herein as a type of module) are used to provide general illumination, as that term is used in the art. FIGS. 1A through 1C show various views of a module 100 in the form of an under cabinet light fixture currently used in the art. Specifically, FIGS. 1A and 1B each show a top-side perspective view of the module 100. FIG. 1C shows a top view of the module 100. The module 100 includes a main housing 105, an optional end cap 110A coupled to one end of the main housing 105, another optional end cap 110B coupled to the opposite end of the main housing 105, and a functional feature 143 (in this case, a light chamber to provide general illumination) integrated with part of the bottom wall (hidden from view) of the housing 105. The functional feature 143 performs the function (lighting) of the module 100. Also shown in FIGS. 1A through 1C is a top cover 106 which allows access to an internal compartment within the main housing 105 of the module 100 for the purpose of, for example, hard wiring one or more electrical conductors from an external power supply.

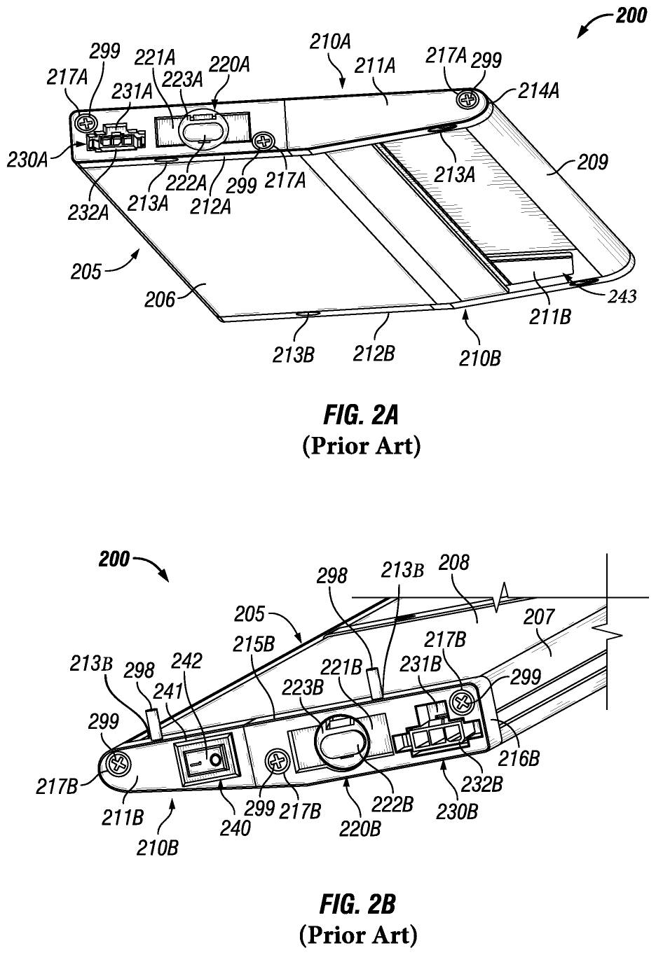

In some cases, the main housing 105 can be configured in such a way that end caps are not needed, and so are not included in the module 100. The end caps 110 are discussed in more detail below with respect to FIGS. 2A and 2B. The module 100 of FIGS. 1A through 1C is designed to have minimal dimensions (particularly in terms of its height, defined as the distance between the top cover 106 and the bottom wall) in order to be unobtrusive when mounted under a cabinet or some other structure. For example, the height of the module 100 can be no greater than ¾ of an inch.

FIGS. 2A and 2B show various views of a module 200 (again, in the form of an under cabinet light fixture) with an optional end cap 210 currently used in the art. Specifically, FIG. 2A shows a bottom-side perspective view of the module 200, and FIG. 2B shows a top-side perspective view of the module 200. In at least some respects, the main housing 205 of the module 200 can be substantially the same as the main housing 105 of the module 100 described above. For example, the main housing 205 of the module 200 of FIGS. 2A and 2B can have a top wall 208, a bottom wall 206, a rear wall 207, and a front wall 209. As another example, the housing 205 in this case has a functional feature 243 (in this case, a light chamber) integrated with part of the bottom wall 206 of the housing, where the functional feature 243 performs the function (lighting) of the module 200.

Referring to FIGS. 1A through 2B, the module 200 can include one or more end caps 210 that are coupled to the housing 205. In this case, the module 200 of FIGS. 2A and 2B includes two end caps 210 (end cap 210A and end cap 210B). End cap 210A and end cap 210B can be configured substantially similar to each other, but in a symmetrical orientation to account for one end cap (e.g., end cap 210A) being disposed on one end of the main housing 210, and the other end cap (e.g., end cap 210B) being disposed on the other end of the main housing 210. In other words, a description of any component of end cap 210A can be substantially the same as the corresponding component for end cap 210B. As a result, the description of such components shall be made without reference to the “A” or “B” version of the end cap 210.

Each end cap 210 can have a body that is defined by at least one wall. In this case, the body of each end cap 210 includes a side wall 211, a top wall 215, a bottom wall 212, another side wall 216, and yet another side wall 214. Each wall of the body of an end cap 210 can have any suitable length, height, and thickness (based, for example, on the configuration of the end of the main housing 205 to which the end cap 210 couples), which can each remain substantially constant or vary along another dimension of the end cap 210. In addition, each wall can be planar and/or non-planar (e.g., have a three-dimensional curvature). Further, each wall has an inner surface (facing toward the inside the light fixture when the end cap 210 is coupled to the main housing 205) and an outer surface (facing away from the module 200).

Each end cap 210 can also include one or more of a number of coupling features that perform one or more functions. For example, each end cap 210 can have multiple coupling features 217 that allow the end cap 210 to couple to the main housing 205 of the module 200. In this case, the coupling features 217 are apertures that traverse the side wall 211 and receive another coupling feature 299 (in this case, a fastening device, such as a screw). Specifically, as shown in FIG. 2A, two coupling features 217A traverse the side wall 211A of end cap 210A, and each coupling feature 217A receives a coupling feature 299. Further, as shown in FIG. 2B, two coupling features 217B traverse the side wall 211B of end cap 210B, and each coupling feature 217B receives a coupling feature 299.

As another example of a coupling feature included with each end cap 210, each end cap 210 can have multiple coupling features 213 that allow the module 200 to couple to a mounting structure (e.g., an under surface of a cabinet). In this case, the coupling features 213 are apertures that traverse the bottom wall 212 and the top wall 215 and receive another coupling feature 298 (in this case, a fastening device, such as a screw or bolt). Specifically, as shown in FIG. 2A, two coupling features 213A traverse the bottom wall 212A of end cap 210A, and two coupling features 213B traverse the bottom wall 212B of end cap 210B. Further, as shown in FIG. 2B, two coupling features 213B traverse the top wall 215B of end cap 210B, and each coupling feature 213B receives a coupling feature 298.

An end cap 210 can also include one or more features that allow power, control, and/or communication signals to enter into and/or leave the module 200. For example, an end cap 210 can include one or more coupling features that can couple to one or more complementary coupling features (e.g., an electrical connector end) of another component (e.g., another module, an electrical cable assembly). In this case, each end cap 210 has coupling feature 220 and coupling feature 230 each disposed on the side wall 211. Each coupling feature (coupling feature 220, coupling feature 230) of an end cap 210 can allow power, control, and/or communication signals to enter into and/or leave the under cabinet module 200.

Specifically, as shown in FIG. 2A, coupling feature 220A and coupling feature 230A traverse the side wall 211A of end cap 210A. Coupling feature 220A includes an electrical connector 222A disposed in an aperture 221A that traverses the side wall 211A, and coupling feature 230A includes an electrical connector 232A disposed in an aperture 231A that traverses the side wall 211A. Further, as shown in FIG. 2B, coupling feature 220B and coupling feature 230B traverse the side wall 211B of end cap 210B. Coupling feature 220B includes an electrical connector 222B disposed in an aperture 221B that traverses the side wall 211B, and coupling feature 230B includes an electrical connector 232B disposed in an aperture 231B that traverses the side wall 211B.

One end cap can have different and/or additional features and/or components compared to the other end cap of the module 200. For example, end cap 210B includes a power control module 240 (e.g., an on/off switch, a dimmer) that is not included with end cap 210A. In this case, as shown in FIG. 2B, the power control module 240 includes a base 241 disposed on the side wall 211B and a switch 242 disposed on the base 241. The switch 242 can be toggled between two or more states by a user to control power signals delivered to one or more components (e.g., a driver) of the module 200.

As discussed above, in some cases, rather than having end caps 210, the housing 205 can be configured in such a way that the end caps 210 are not required. For example, if the housing 205 is formed from a mold and includes both ends, there is no need for end caps. In such a case, one or both ends of the housing 205 can include one or more coupling features (e.g., coupling feature 220, coupling feature 230). In some cases, regardless of whether the module 200 includes end caps 210, one or more coupling features can be disposed at some other location (e.g., rear wall 207, top cover 206) on the housing 205 of the module 200.

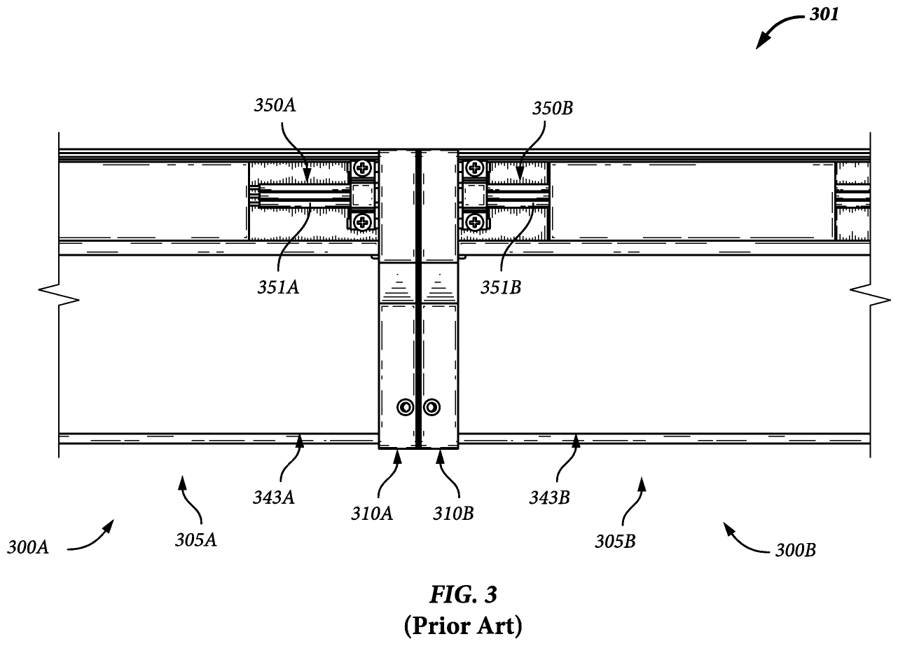

FIG. 3 shows a bottom view of an assembly 301 of a couple of modules 300 (module 300A and module 300B) in the form of under cabinet light fixtures (having a function feature 343 of generating light for general illumination) coupled to each other, as currently used in the art. Module 300A and module 300B are substantially similar to the modules of FIGS. 1A through 2B discussed above. For example, module 300A has a functional feature 343A (in this case, in the form of a light chamber) integrated with the housing 305A, where the functional feature 343A is part of the function (lighting) of the module 300A. Module 300A has an end cap 310A coupled to the housing 305A. There is also an electrical cable assembly 350A partly disposed within the housing 305A, where the electrical cable assembly 350A includes an electrical cable 351A that can carry power, control, data, and/or communication signals used and/or generated by the module 300A. In this case, part of the housing 305A is removed to show the electrical cable assembly 350A for illustration purposes.

Similarly, module 300B has a functional feature 343B (in this case, in the form of a light chamber) integrated with the housing 305B, where the functional feature 343B is part of the function (lighting) of the module 300B. Module 300B has an end cap 310B coupled to the housing 305B. There is also an electrical cable assembly 350B partly disposed within the housing 305B, where the electrical cable assembly 350B includes an electrical cable 351B that can carry power, control, data, and/or communication signals used and/or generated by the module 300B. In this case, part of the housing 305B is removed to show the electrical cable assembly 350B for illustration purposes.

In some cases, the electrical cable 351A of the electrical cable assembly 350A and the electrical cable 351B of the electrical cable assembly 350B can be a single continuous electrical cable 351. In any case, each electrical cable 351 can have one or more coupling features (e.g., electrical connector end) that can be used to couple to some component (e.g., a module 300, another electrical cable 351) of the assembly 301. Alternatively, an end of the electrical cable 351 can be exposed electrical conductors that are received by a coupling feature (e.g., a terminal block) disposed within the housing 305A of the module 300A. In this configuration, module 300A and module 300B abut against each other, so that end cap 310A abuts against end cap 310B.

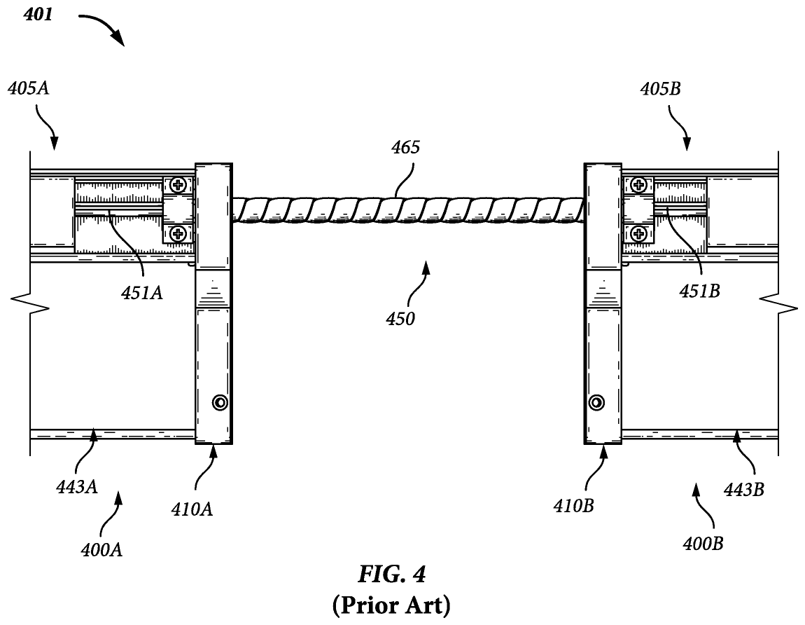

FIG. 4 shows a bottom view of an assembly 401 of a couple of modules 400 (module 400A and module 400B) in the form of under cabinet light fixtures (having a function feature 443 of generating light for general illumination) coupled to each other, as currently used in the art. Module 400A and module 400B are substantially similar to the modules of FIGS. 1A through 3 discussed above. For example, module 400A has a functional feature 443A (in this case, in the form of a light chamber) integrated with the housing 405A, where the functional feature 443A is part of the function (lighting) of the module 400A. Module 400A has an end cap 410A coupled to the housing 405A. There is also an electrical cable 451A of an electrical cable assembly 450 that can carry power, control, data, and/or communication signals used and/or generated by the module 400A. The electrical cable 451A is disposed within the housing 405A and can be part of an electrical cable assembly 450, which can be similar to the electrical cable assembly 350A described above with respect to FIG. 3. In this case, part of the housing 405A is removed to show part of the electrical cable 451A for illustration purposes.

Similarly, module 400B has a functional feature 443B (in this case, in the form of a light chamber) integrated with the housing 405B, where the functional feature 443B is part of the function (lighting) of the module 400B. Module 400B has an end cap 410B coupled to the housing 405B. There is also an electrical cable 451B of the electrical cable assembly 450 that can carry power, control, data, and/or communication signals used and/or generated by the module 400B. The electrical cable 451B is disposed within the housing 405B and can be part of the electrical cable assembly 450, such as the electrical cable assembly 350B described above with respect to FIG. 3. In this case, part of the housing 405B is removed to show part of the electrical cable 451B for illustration purposes. Electrical cable 451A and electrical cable 451B can be opposite ends of the same electrical cable 451. Alternatively, electrical cable 451A and electrical cable 451B can be different electrical cables.

Part of the electrical cable assembly 450 shown in FIG. 4 is disposed between module 400A and module 400B. In this case, the electrical cable assembly 450 includes a conduit 465 that is used to protect an electrical cable 451 disposed therein. In this case, the electrical cable 451 disposed within the conduit 465 can be part of electrical cable 451A and/or electrical cable 451B. Alternatively, the electrical cable 451 disposed within the conduit 465 can be a separate electrical cable that is electrically coupled to electrical cable 451A and electrical cable 451B. In any case, each electrical cable 451 of FIG. 4 can have one or more coupling features (e.g., electrical connector end) that can be used to couple to some component (e.g., a module 400, another electrical cable 451, a terminal block) of the assembly 401.

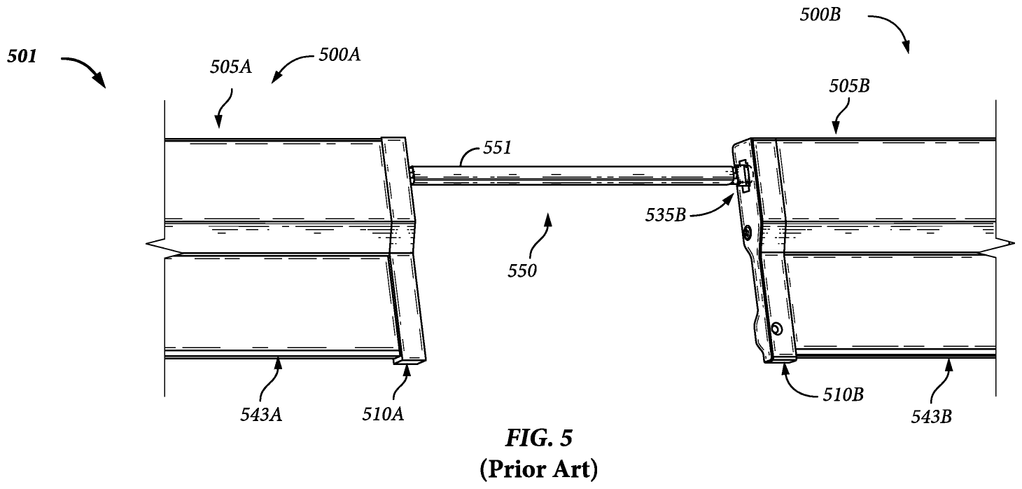

FIG. 5 shows a bottom view of an assembly 501 of a couple of modules 500 (module 500A and module 500B) in the form of under cabinet light fixtures (having a function feature 543 of generating light for general illumination) currently used in the art. Module 500A and module 500B are substantially similar to the modules of FIGS. 1A through 4 above. For example, module 500A has a functional feature 543A (in this case, in the form of a light chamber) integrated with the housing 505A, where the functional feature 543A is part of the function (lighting) of the module 500A. Module 500A has an end cap 510A coupled to the housing 505A. In this case, the housing 505A is intact, as in normal operations, and so the portion of the electrical cable assembly 550 disposed within the housing 505A is hidden from view.

Similarly, module 500B has a functional feature 543B (in this case, in the form of a light chamber) integrated with the housing 505B, where the functional feature 543B is part of the function (lighting) of the module 500B. Module 500B has an end cap 510B coupled to the housing 505B. In this case, the housing 505B is intact, as in normal operations, and so the portion of the electrical cable assembly 550 disposed within the housing 505B is hidden from view.

A portion of the electrical cable assembly 550 of FIG. 5 is disposed between module 500A and module 500B. In this case, the electrical cable assembly 550 includes an electrical cable 551 having at least one coupling feature 535B disposed at one end. In this case, the electrical cable 551 can be part of an electrical cable disposed within the housing 505A of module 500A and/or electrical cable disposed within the housing 505B of module 500B. Alternatively, the electrical cable 551 can be a separate component that is electrically coupled to the electrical cable (or other wiring) disposed within the housing 505A of module 500A and the electrical cable (or other wiring) disposed within the housing 505B of module 500B.

The coupling feature 535B (e.g., an electrical connector end) is used in this case to couple to a complementary coupling feature (e.g., another electrical connector end, such as coupling feature 230A of FIG. 2A) disposed within the end cap 510B of module 500B. While hidden from view, the electrical cable assembly 550 can also include another coupling feature (e.g., another electrical connector end) that couples to a complementary coupling feature (e.g., another electrical connector end) disposed within the end cap 510A of module 500A. In this configuration, as with the configuration shown in FIG. 4, module 500A and module 500B are physically separated from each other but retain electrical continuity by the electrical conductors disposed inside the electrical cable 551 of the electrical cable assembly 550.

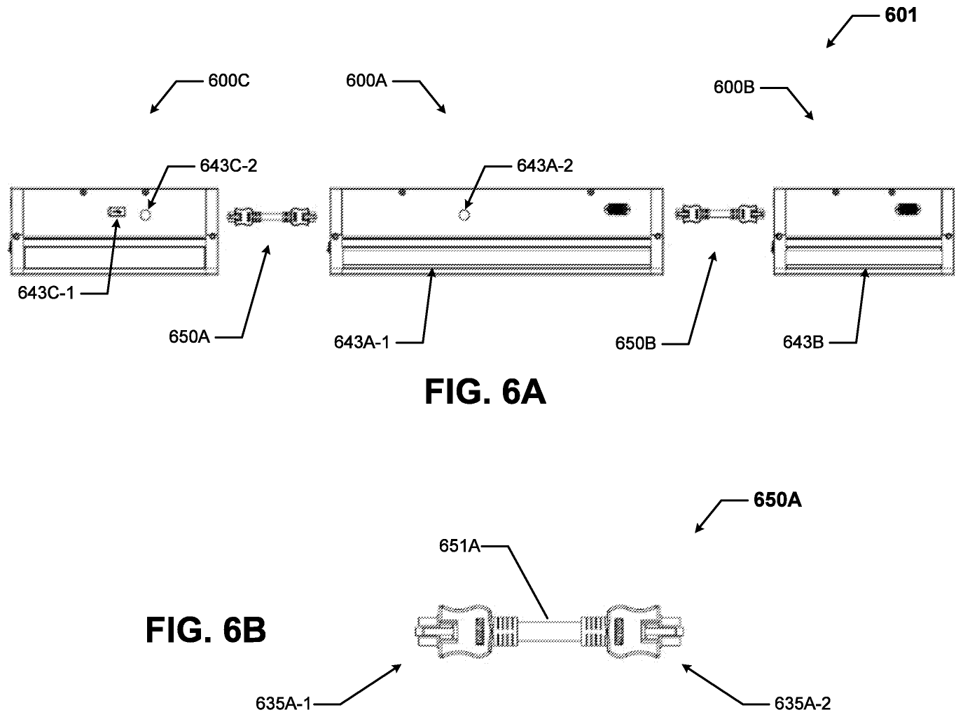

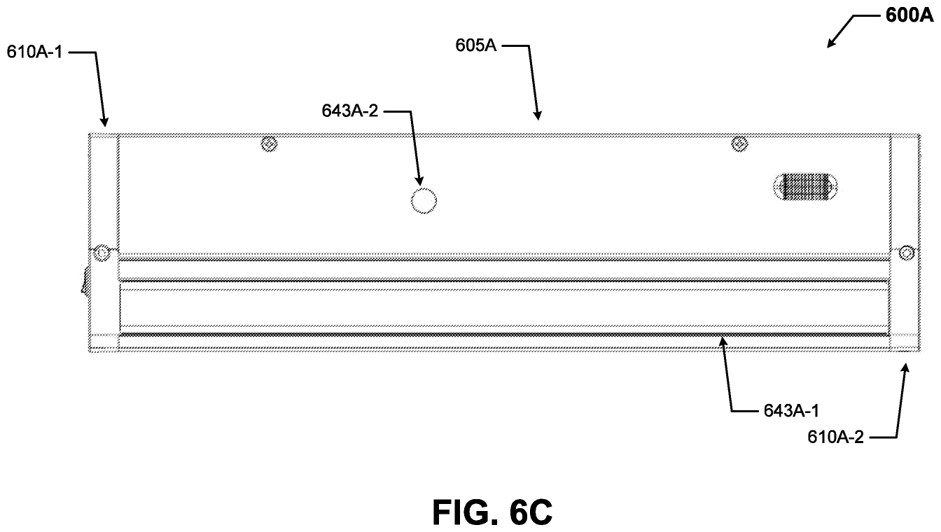

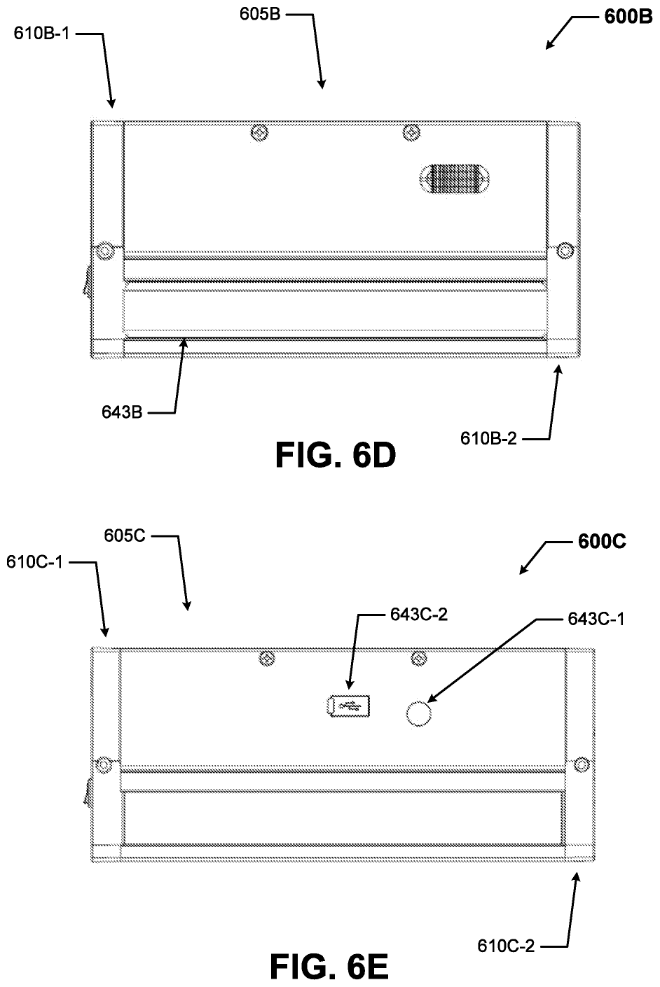

FIGS. 6A through 6E show various views of a subassembly 601 having multiple modules 600 coupled to each other in accordance with certain example embodiments. Specifically, FIG. 6A shows a top exploded view of the subassembly 601. FIG. 6B shows an electrical cable assembly 650A of FIG. 6A. FIG. 6C shows a top view of module 600A of the subassembly 601 of FIG. 6A. FIG. 6D shows a top view of module 600B of the subassembly 601 of FIG. 6A. FIG. 6E shows a top view of module 600E of the subassembly 601 of FIG. 6A. Each of the modules 600 of the subassembly 601 of FIGS. 6A-6E can be substantially the same as the modules described above with respect to FIGS. 1 through 5, except for at least the functional features of at least one of the modules 600 of the subassembly 601.

Referring to FIGS. 1 through 6E, each example module 600 of the subassembly 601 is configured to include one or more functional features 643 that are not traditionally found in an existing under cabinet light fixture, such as the modules shown above with respect to FIGS. 1 through 5. Further, each example module 600 (module 600A, module 600B, module 600C) of the subassembly 601, on its own (operating in isolation), is configured to comply with one or more standards and/or one or more energy efficiency programs (e.g., the ENERGY STAR® program). In this way, when multiple example modules 600 are coupled to each other to form the subassembly 601, then the subassembly 601 can also comply with such standards and/or energy efficiency programs.

The electrical cable assembly 650A is disposed between and is electrically coupled to module 600A and module 600C, and the electrical cable assembly 650B is disposed between and is electrically coupled to module 600A and module 600B. The electrical cable assembly 650A of FIGS. 6A and 6B can be substantially the same as the electrical cable assembly 650B of FIG. 6A. Alternatively, electrical cable assembly 650A and electrical cable assembly 650B can be different from each other in at least one respect (e.g., length of the electrical cable 651, configuration of a coupling feature 635 (electrical connector)). Also, the electrical cable assemblies 650 of FIGS. 6A and 6B can be substantially the same as the electrical cable assemblies described above with respect to FIGS. 3-5. For example, electrical cable assembly 650A of FIGS. 6A and 6B includes an electrical cable 651A and a coupling feature 635 (coupling feature 635A-1 and coupling feature 635A-2) at each end.

The coupling feature 635A-1 (e.g., an electrical connector end) at one end of the electrical cable 651A of the electrical cable assembly 650A is used in this case to couple to a complementary coupling feature (e.g., another electrical connector end) disposed in module 600C. Similarly, coupling feature 635A-2 (e.g., an electrical connector end) at the other end of the electrical cable 651A of the electrical cable assembly 650A is used in this case to couple to a complementary coupling feature (e.g., another electrical connector end) disposed in module 600A. The electrical cable 651A of the electrical cable assembly 650A can have any of a number of electrical conductors of any of a number of sizes and have any of a number of lengths.

As shown in FIG. 6A, the electrical cable assembly 650B has a coupling feature at each end (configured substantially the same as the coupling features 635 of the electrical cable assembly 650A), where one coupling feature couples to a complementary coupling feature of module 600A, and where the other coupling feature couples to a complementary coupling feature of module 600C. In alternative embodiments, an electrical cable assembly 650 can use wireless technology for the transfer of power (e.g., using inductive power transfer), control (e.g., using wireless communication technology), communication, and/or any other type of signal between modules 600.

Module 600A of FIGS. 6A and 6C can be substantially the same as the modules of FIGS. 3 through 5 discussed above, except as described below. For example, module 600A has a functional feature 643A-1 (in this case, in the form of a light chamber) integrated with the housing 605A, where the functional feature 643A-1 is part of the function (lighting) of the module 600A. Module 600A has two end caps 610A (end cap 610A-1 and end cap 610A-2) coupled to the housing 605A. In this case, the housing 605A is intact, as in normal operations, and so an electrical cable assembly disposed within the housing 605A is hidden from view.

However, unlike the modules discussed above and found in the current art, module 600A also includes an additional functional feature 643A-2 that in this case is in the form of a sensor module. In such a case, the functional feature 643A-2 can include one or more of any of a number of sensors, including but not limited to a passive infrared sensor, an ambient light sensor, a temperature sensor, a humidity sensor, a pressure sensor, a gas sensor, a carbon monoxide sensor, and a smoke sensor.

Further, when the functional feature 643A-2 is a sensor, the sensor can measure one or more of any number of parameters, including but not limited to power (e.g., current, voltage), light, temperature, pressure, humidity, smoke, gas content, and air flow. When the functional feature 643A-2 is a sensor, the sensor can be used in the operation of one or more other functional features of the module 600A and/or another module 600 (e.g., module 600C) in the subassembly 601.

Alternatively, when the functional feature 643A-2 is a sensor, the sensor can be used for some purpose independent of the other functional features 643 in the subassembly 601. In such a case, a network manager, master controller, or some other control element of a larger or different system can use the parameter measured by the sensor. For example, if the sensor is a smoke sensor, then the functional feature 643A-2 can be communicably coupled to a fire protection system that is independent of a lighting system of which functional feature 643A-1 is a part.

In some cases, if the addition of a sensor module to the module 600A results in a level of consumed power that exceeds a value that complies with some standard or certification (e.g., the ENERGY STAR® program), then an additional module (e.g., module 600D) can be added to the subassembly 601. In such a case, the additional module can have a functional feature of sensing capability. (In certain example embodiments, the additional module would have no other functional features aside from sensing capability.) In this way, when the additional module is in communication with module 600A, then the measured parameters (e.g., an amount of ambient light, motion) of the sensor of the additional module can be used to operate the light source of module 600A. By having separate modules, module 600A and the additional module can independently comply with a standard or certification, thereby allowing the subassembly 601 to be in compliance with that standard or certification.

Module 600B of FIGS. 6A and 6D can be substantially the same as the modules of FIGS. 3 through 5 discussed above. For example, module 600B has a functional feature 643B (in this case, in the form of a light chamber) integrated with the housing 605B, where the functional feature 643B is part of the function (lighting) of the module 600B. Module 600B has two end caps 610B (end cap 610B-1 and end cap 610B-2) coupled to the housing 60BA. In this case, the housing 605B is intact, as in normal operations, and so an electrical cable assembly disposed within the housing 605B is hidden from view.

Module 600C of FIGS. 6A and 6E can be substantially the same as the modules discussed above, except as described below. For example, module 600C has two end caps 610C (end cap 610C-1 and end cap 610C-2) coupled to the housing 605C. In this case, the housing 605C is intact, as in normal operations, and so an electrical cable assembly disposed within the housing 605C is hidden from view. Module 600C also has two functional features 643C (functional feature 643C-1 and functional feature 643C-2), but neither of these functional features 643C are in the form of a light chamber.

Functional feature 643C-2 in this case is in the form of another sensor module, which can be substantially similar to the sensor module of the functional feature 643A-2 of module 600A discussed above. The sensor of the functional feature 643C-1 can measure the same parameter as, or a different parameter (e.g., infrared radiation) than, the sensor of the functional feature 643A-2 of module 600A.

Functional feature 643C-1 in this case is in the form of a USB port (e.g., type A, type C), which can be used for one or more of a number of purposes (e.g., to charge an electrical device (e.g., a cell phone, a MP3 player), to transfer (e.g., send, receive) files or other data, to add a device (e.g., a speaker, a microphone, an antenna)). As discussed above, in addition or in the alternative, a module 600 can include a functional feature 643 that includes a feature such as, for example, one or more energy storage devices (e.g., batteries), a ground fault circuit interrupter (GFCI) receptacle, a wireless router, a modem, and a voice-activated controller.

The housings 605 of the modules 600 of the subassembly 601 of FIGS. 6A through 6E can vary from each other in some respects (e.g., have different lengths, have different widths), but all of the housings 605 can have similar features. For example, the housing 605 of each module 600 of the subassembly 601 can have substantially the same height and physical appearance (e.g., color scheme, inclusion or omission of end caps). Also, while the modules 600 shown in FIG. 6 are connected in series with each other, in certain example embodiments one or more modules 600 (or additional modules not shown in FIG. 6A) can be connected in parallel with at least one other module in the subassembly 601.

When one module 600 in the subassembly 601 is connected to another module 600 in the subassembly 601 using wireless technology or one or more coupling features in the form of electrical connectors, the relative position of the two modules 600 can be easily changed by a user, allowing the user to maximize the footprint or space provided under one or more cabinets (or any other location where the modules 600 can be mounted).

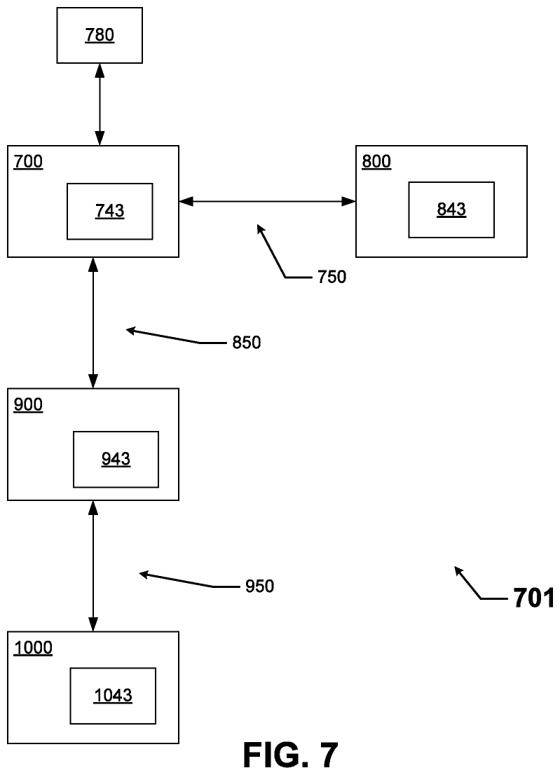

FIG. 7 shows a block diagram of a subassembly 701 having multiple modules coupled to each other in accordance with certain example embodiments. Referring to FIGS. 1 through 7, the subassembly 701 of FIG. 7 has four modules. Module 700 has functional feature 743, module 800 has functional feature 843, module 900 has functional feature 943, and module 1000 has functional feature 1043. The various modules, functional features, electrical cable assemblies, and other components and/or features of the subassembly 701 of FIG. 7 can be substantially similar to the corresponding modules, functional features, electrical cable assemblies, and other components and/or features discussed above.

Module 700 is connected to module 800 using electrical cable assembly 750. Module 700 is also connected to module 900 using electrical cable assembly 850. Finally, module 900 is connected to module 1000 using electrical cable assembly 950. In this way, module 700, module 900, and module 1000 are connected in series with each other, and module 800 is connected in parallel with module 900 and module 1000. In certain example embodiments, one or more of the electrical cable assemblies of FIG. 7 can be replaced, in whole or in part, with wireless technology (e.g., inductive power transfer, WiFi, Zigbee) to transfer one or more types (e.g., power, control, data, communication) of signals. In this example, the housing of each module of FIG. 7 can have the same height (although the lengths and widths can differ), general shape (e.g., inclusion or exclusion of end caps), and color scheme as the housing of the other modules of the subassembly 701.

The various functional features of the modules in the subassembly 701 of FIG. 7 can differ from each other. For example, the functional feature 743 of module 700 can be a light source that provides general illumination. The functional feature 843 of module 800 can be a sensor that measures one or more parameters that are used to operate the light source of module 700. The functional feature 943 of module 900 can be a voice-activated controller, which can be used to control the light source of module 700 and/or other modules of the subassembly 701 and/or devices located proximate to the subassembly 701. The functional feature 943 of module 900 can be one or more USB ports.

Power to all of the modules of the subassembly 701 can be provided by a power source 780. The power source 780 provides AC mains or some other form of power to one or more modules within the subassembly 701. The power source 780 can include one or more of a number of components. Examples of such components can include, but are not limited to, an electrical conductor, a coupling feature (e.g., an electrical connector), a transformer, an inductor, a resistor, a capacitor, a diode, a transistor, and a fuse. The power source 780 can be, or include, for example, a wall outlet, an energy storage device (e.g. a battery, a supercapacitor), a circuit breaker, and/or an independent source of generation (e.g., a photovoltaic solar generation system). Alternatively, or in addition, one or more modules (e.g., module 700) can include one or more energy storage devices, which can provide power to one or more modules of the subassembly 701 when the power source 780 is unavailable.

Example modules can be installed without complicated electrical and/or mechanical manipulation or expertise, as with traditional under-cabinet light fixtures. In a system (e.g., a subassembly), at least one module can include a functional feature that is not traditionally found in an under-cabinet light fixture. Each example module can be coupled to another example module and/or currently-known under-cabinet light fixture using traditional coupling methods (e.g., electrical cable assembly, wirelessly (e.g., using inductive power transfer, using wireless communication). Each example module in a system, regardless of its functional features, are configured to comply with any of a number of standards and/or energy efficiency programs. The example modules are designed to be modular, meaning that an example can be added, removed, or relocated without affecting the performance of the other modules in the system. Using example embodiments described herein, the light fixture can be more energy efficient, provide particular types of lighting and other functional features, and provide a number of other benefits expressed or implied herein.

Although embodiments described herein are made with reference to example embodiments, it should be appreciated by those skilled in the art that various modifications are well within the scope and spirit of this disclosure. Those skilled in the art will appreciate that the example embodiments described herein are not limited to any specifically discussed application and that the embodiments described herein are illustrative and not restrictive. From the description of the example embodiments, equivalents of the elements shown therein will suggest themselves to those skilled in the art, and ways of constructing other embodiments using the present disclosure will suggest themselves to practitioners of the art. Therefore, the scope of the example embodiments is not limited herein.

What is claimed is:

1. A modular under cabinet system comprising:
a first under cabinet module disposed in a first location, wherein the first under cabinet module performs a first function, wherein the first under cabinet module receives power from a source, wherein the first under cabinet module performs the first function using the power; and
a second under cabinet module disposed in a second location, wherein the second under cabinet module is coupled to the first under cabinet module to allow for the transfer of the power therebetween, wherein the second under cabinet module performs a second function using the power.

2. The modular under cabinet system of claim 1, wherein the first function of the first under cabinet module is independent of the second function of the second under cabinet module.

3. The modular under cabinet system of claim 2, wherein the first function of the first under cabinet module comprises emitting light, and wherein the second function of the second under cabinet module comprises providing a USB port.

4. The modular under cabinet system of claim 2, wherein the first function of the first under cabinet module comprises emitting light, and wherein the second function of the second under cabinet module comprises measuring a parameter used to control emitting the light by the first under cabinet module.

5. The modular under cabinet system of claim 1, further comprising:
an electrical cable assembly comprising an electrical cable having a first end and a second end, wherein the first end is coupled to a first coupling feature of the first under cabinet module, and wherein the second end is coupled to a second coupling feature of the second under cabinet module.

6. The modular under cabinet system of claim 5, wherein the first coupling feature comprises a first electrical connector end, wherein the first end of the electrical cable of the electrical cable assembly comprises a first complementary electrical connector end that couples to the first electrical connector end of the first coupling feature.

7. The modular under cabinet system of claim 1, further comprising:
a third under cabinet module disposed in a third location, wherein the third under cabinet module comprises a third coupling feature; and
an electrical cable assembly comprising an electrical cable having a third end and a fourth end, wherein the third end is coupled to the third coupling feature of the third under cabinet module, and wherein the fourth end is coupled to a fourth coupling feature of the first under cabinet module, wherein the power flows through the electrical cable assembly.

8. The modular under cabinet system of claim 7, wherein the third under cabinet module performs the first function using the power.

9. The modular under cabinet system of claim 8, wherein the third under cabinet module performs a third function using the power.

10. The modular under cabinet system of claim 9, wherein the first under cabinet module, when performing the first function, meets requirements for energy efficiency certification, and wherein the second under cabinet module, when performing the second function, meets the requirements for energy efficiency certification.

11. The modular under cabinet system of claim 7, wherein the first under cabinet module, the second under cabinet module, and the third under cabinet module are connected in series with each other.

12. The modular under cabinet system of claim 7, wherein the first under cabinet module is directly connected to the second under cabinet module and the third under cabinet module, wherein the second under cabinet module and the third under cabinet module are connected in parallel with each other.

13. The modular under cabinet system of claim 1, wherein the first under cabinet module comprises a first housing having a first height, wherein the second under cabinet module comprises a second housing have the first height.

14. An under cabinet module of a modular under cabinet system, comprising:
a housing comprising a body;
a first coupling feature disposed on the body of the housing, wherein the first coupling feature is configured to couple to a first adjacent module of the modular under cabinet system; and
a first functional feature disposed, at least in part, within the body of the housing, wherein the first functional feature does not provide general illumination,
wherein the first functional feature consumes an amount of energy that is less than a threshold required for energy efficiency certification.

15. The under cabinet module of claim 14, further comprising:
a second coupling feature disposed on the body of the housing, wherein the second coupling feature is configured to couple to a second adjacent module of the modular under cabinet system.

16. The under cabinet module of claim 14, wherein the first functional feature comprises a USB port used to supply power to an electrical device.

17. The under cabinet module of claim 14, wherein the housing has a thickness that is substantially the same as that of a second housing of the first adjacent module.

18. The under cabinet module of claim 14, wherein the first functional feature comprises a ground fault circuit interrupter receptacle.

19. The under cabinet module of claim 14, wherein the first functional feature comprises a sensor device.

20. The under cabinet module of claim 14, wherein the first functional feature comprises a voice-activated controller.
